(19) United States
(12) Patent Application Publication
(10) Pub. No.: US 2009/0006500 A1
(43) Pub. Date: Jan. 1, 2009

(54) NAMESPACE REPLICATION PROGRAM, NAMESPACE REPLICATION DEVICE, AND NAMESPACE REPLICATION METHOD

(75) Inventors: Kensuke Shiozawa, Kawasaki (JP); Yoshitake Shinkai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/204,883

(22) Filed: Sep. 5, 2008

Related U.S. Application Data
(63) Continuation of application No. PCT/JP2006/306284, filed on Mar. 28, 2006.

(51) Int. Cl. G06F 17/30

(52) U.S. Cl. 707/204; 707/E17.007

(57) ABSTRACT

A namespace replication database update step that acquires events relating to namespace update from a FS control server 112 for controlling a primary storage 133 and updates, based on the events, a namespace replication DB 132 created based upon inode information and link information in the primary storage 133; and a namespace replication database correction step that acquires inode information having ctime after a predetermined time and link information corresponding to the inode information from the FS control server 112, and corrects the namespace replication DB 132 if events which have not been reflected on the namespace replication DB 132 are lost, are caused to be performed by the computer

### TECHNICAL FIELD

The present invention relates to a namespace replication program, a namespace replication device, and a namespace replication method for improving performance in replicating a namespace on a storage device, particularly in searching the entire namespace.

### BACKGROUND ART

An HSM (Hierarchical Storage Management) is a technique that combines a low-speed storage device (secondary storage) such as a tape library and a high-speed storage device (primary storage) such as a hard disk to build a low cost and large capacity file system.

An HSM control apparatus needs to have a function of identifying files which have not been accessed for a long time in the primary storage, writing out the files to the secondary storage, and, if an access request is made thereto, moving back the files to the primary storage. Conventionally, in order to realize this function, the HSM control apparatus uses a method for searching the entire namespace in a file system having a hierarchical structure and referring to access time that the file system retains on a file by file basis to thereby identify the file to be written out to the secondary storage.

As a related art relevant to the present invention, there is known Patent Document 1 described below. A data processor disclosed in Patent Document 1 collects log data every time the content of meta data is updated and uses the collected log data to correct inconsistency in the file system.
Patent Document 1: Jpn. Pat Appln. Laid-Open Publication No. 2000-484995

### DISCLOSURE OF THE INVENTION

### Problems to be Solved by the Invention

However, there exist the following problems in the HSM control device using the above method for searching the entire namespace.

The first problem is overhead incurred by searching the file system. That is, the conventional HSM periodically searches the entire file namespace having a hierarchical structure, thereby incurring a large overhead.

The second problem is exclusion problem in the namespace. When a file name change operation such as “rename” operation is made to a given file during the searching of the entire namespace, a path name of the file acquired in the searching becomes invalid one which does not actually exist. Therefore, the HSM control apparatus is likely to perform a data migration operation inconsistently with a policy that a customer has set. For example, assuming that an upper directory is migrated to a recycle bin in the middle of the searching, all the items in the recycle bin are likely to be set as an object to be migrated. In order to prevent this, it is necessary for the HSM control apparatus to frequently check inconsistency in the course of the searching of the entire namespace and, if there finds inconsistency, to start the searching from the beginning again, thereby making the logic very complicated and significantly increasing overhead.

The third problem is flexibility in HSM policy control. Since the namespace having a hierarchical structure generally represents the attribute of stored files, it is natural to set (HSM policy of all files under a given directory, etc.) the HSM policy based on the namespace. However, the abovementioned exclusion problem in the namespace makes it difficult to realize a complicated policy control based on the namespace.

The fourth problem is deficiency of the attribute information of the data saved in the secondary storage. Further, it is difficult to add a correct path name to the data stored in the secondary storage due to the exclusion problem in the namespace. Therefore, the data stored in the secondary storage can be accessed only using the meta data of the file system. Thus, if the meta data in the file system become corrupted, association between the meta data and path name of the data stored in the secondary storage is made invalid. Thus, in this case, the file data cannot be recovered although they exist on the secondary storage.

The present invention has been made in order to solve the above-described problems and has an object of providing a namespace replication program, a namespace replication device, and a namespace replication method for efficiently replicating a namespace on a storage device.

### Means for Solving the Problems

In order to solve the above-described problems, the present invention relates to a namespace replication program causing a computer to replicate a namespace on a storage device, the program causing the computer to execute: a namespace replication database update step that acquires namespace update information which is information relating to updating the namespace from a file system controller for controlling the storage device and updates, based on the namespace update information, a namespace replication database, which is a database created based upon file identification information and link information in the storage device, and a namespace replication database correction step that acquires unupdated file identification information which is file identification information updated after a predetermined time and unupdated link information which is link information corresponding to the unupdated file identification information from the file system controller and corrects the namespace replication database based upon the unupdated file identification information and the unupdated link information when the namespace update information which has not been reflected on the namespace replication database by the namespace replication database update step is lost.

In the namespace replication program according to the present invention, the namespace update information contains a namespace update content, which is an updated namespace content, and a namespace update time, which is an update time for the namespace, and among the namespace update times contained in the namespace update information which has been reflected on the namespace replication database by the namespace replication database update step, the namespace replication database correction step sets the latest one as the predetermined time.

In the namespace replication program according to the present invention, the namespace replication database correction step sets link information contained in a directory file among files shown by the unupdated file identification information as the unupdated link information.

In the namespace replication program according to the present invention, the namespace replication database information correction step extracts and acquires the unupdated file identification information and the unupdated link information by notifying the file system controller of the predetermined time.

In the namespace replication program according to the present invention, the namespace replication database information correction step acquires namespace update information which has not been reflected on the namespace replication database by the namespace replication database update step before completing the correction of the namespace replication database, and updates the namespace replication database based upon the acquired namespace update information if the namespace update information has no relationship to the unupdated file identification information.

In the namespace replication program according to the present invention, one of the link information contains inode information for one directory file as well as inode information for a child file contained in the directory file and name information for a child file contained in the directory file, and the namespace replication database has an entry for each of the link information.

In the namespace replication program according to the present invention, the file identification information is inode information, and the link information contains an inode number for one directory file and an inode number for a child file contained in the directory file.

In the namespace replication program according to the present invention, the namespace replication database information correction step acquires namespace update information which has not been reflected on the namespace replication database by the namespace replication database update step before completing the correction of the namespace replication database, and corrects the namespace replication database based upon the newer one of the namespace update information and the unupdated file identification information by comparing the namespace change time of the namespace update information with the update time of the upupdated file identification information having some relationship to the namespace update information if the namespace update information has any relationship to the unupdated file identification information.

Moreover, in the namespace replication program according to the present invention, the namespace update information is sent collectively in each predetermined period of time by the file system controller, and the namespace replication database information update step updates the namespace replication database based on the namespace update information each time the namespace replication database information update step acquires the namespace update information.

The present invention relates to a namespace replication device for replicating a namespace on a storage device, comprising: a namespace replication database update section that acquires namespace update information, which is information relating to updating the namespace, from a file system controller for controlling the storage device and updates a namespace replication database, which is a database created based upon file identification information and link information in the storage device, based on the namespace update information; and a namespace replication database correction section that acquires unupdated file identification information, which is file identification information updated after a predetermined time, and unupdated link information, which is link information corresponding to the unupdated file identification information, from the file system controller and corrects the namespace replication database based upon the unupdated file identification information and the unupdated link information if the namespace update information which has not been reflected on the namespace replication database by the namespace replication database update section is lost.

In the namespace replication device according to the present invention, the namespace update information contains a namespace update content, which is an updated namespace content, and a namespace update time, which is an update time for the namespace, and among the namespace update times contained in the namespace update information which has been reflected on the namespace replication database by the namespace replication database update section, the namespace replication database correction section sets the latest one as the predetermined time.

The present invention relates to a namespace replication method for replicating a namespace on a storage device, the method including: a namespace replication database update step that acquires namespace update information, which is information relating to updating the namespace, from a file system controller for controlling the storage device in the namespace replication device for managing a namespace replication database, which is a database created based upon file identification information and link information of the storage device, and updates the namespace replication database based upon the namespace update information; and a namespace replication database correction step that acquires unupdated file identification information, which is file identification information updated after a predetermined time, and unupdated link information, which is link information corresponding to the unupdated file identification information, in the namespace replication device from the file system controller and corrects the namespace replication database based upon the unupdated file identification information and the unupdated link information when the namespace update information which has not been reflected on the namespace replication database by the namespace replication database update step is lost.

In the namespace replication method according to the present invention, the namespace update information contains a namespace update content, which is an updated namespace content, and a namespace update time, which is an update time for the namespace, and among the namespace update times contained in the namespace update information which has been reflected on the namespace replication database by the namespace replication database update step, the namespace replication database correction step sets the latest one as the predetermined time.

In the namespace replication method according to the present invention, the namespace replication database correction step sets link information contained in a directory file among files shown by the unupdated file identification information as the unupdated link information.

In the namespace replication method according to the present invention, the namespace replication database information correction step acquires the unupdated file identification information in the namespace replication device by notifying the file system controller of the predetermined time in the namespace replication device, enumerating file identification information updated after the predetermined time in the file system controller, and sending the file identification information as unupdated file identification information to the namespace replication device.

In the namespace replication method according to the present invention, the namespace replication database information correction step acquires namespace update information which has not been reflected on the namespace replication database by the namespace replication database update step before completing the correction of the namespace replication database in the namespace replication device, and updates the namespace replication database based upon the acquired namespace update information if the namespace update information has no relationship to the unupdated file identification information.

In the namespace replication method according to the present invention, one of the link information contains inode information for one directory file as well as inode information for a child file contained in the directory file and name information for a child file contained in the directory file, and the namespace replication database has an entry for each of the link information.

In the namespace replication method according to the present invention, the file identification information is inode information, and the link information contains an inode number for one directory file and an inode number for a child file contained in the directory file.

In the namespace replication method according to the present invention, the namespace replication database information correction step acquires namespace update information which has not been reflected on the namespace replication database by the namespace replication database update step before completing the correction of the namespace replication database in the namespace replication device, and corrects the namespace replication database based upon the newer one of the namespace update information and the unupdated file identification information by comparing the namespace change time of the namespace update information with the update time of the unupdated file identification information having some relationship to the namespace update information if the namespace update information has any relationship to the unupdated file identification information.

Moreover, in the namespace replication method according to the present invention, the namespace replication database information update step records database maintenance information instructing the maintenance of the namespace replication database in the storage device in case of an orderly termination in the file system controller and determines that the namespace update information which has not been reflected on the namespace replication database by the namespace replication database update step is lost when the database maintenance information is not found in the storage device at the time of starting the file system controller, causing the namespace replication device to perform the namespace replication database correction step.

### BRIEF DESCRIPTION OF THE DRAWINGS

FIG. 1 is a block diagram showing an example of a configuration of an HSM system according to a precondition technique 1;

FIG. 2 is a flowchart showing an example of operation of file information acquisition processing according to the precondition technique 1;

FIG. 3 is a view showing an example of a hierarchical structure of a directory in the namespace according to the precondition technique 1;

FIG. 4 is a flowchart showing an example of operation of file information acquisition processing according to a precondition technique 1;

FIG. 5 is a flowchart showing an example of operation of event data reflection processing according to a precondition technique 1;

FIG. 6 is a flowchart showing an example of operation of migration determination processing according to a precondition technique 1;

FIG. 7 is a block diagram showing an example of a configuration of a HSM system according to a first embodiment;

FIG. 8 is a block diagram showing an example of detailed configuration and operation of the HSM system according to the first embodiment;

FIG. 9 is a flowchart showing an example of operation of namespace replication mode determination processing according to the first embodiment;

FIG. 10 is a block diagram showing an example of a data structure relating to the namespace according to the first embodiment;

FIG. 11 is a table showing an example of types and contents of events according to the first embodiment;

FIG. 12 is a sequence diagram showing an example of operation of namespace DB correction processing according to the first embodiment;

FIG. 13 is a tree-structured diagram showing an example of the content of a namespace in a primary storage at the time of event loss;

FIG. 14 is a tree-structured diagram showing an example of the content of a namespace table at the time of event loss;

FIG. 15 is a tree-structured diagram showing an example of the content of a namespace table at the time of inode information correction;

FIG. 16 is a tree-structured diagram showing an example of the content of a namespace table at the time if an event having no relationship to the corrected inode information was reflected; and

FIG. 17 is a tree-structured diagram showing an example of the content of a namespace table at the time of link information correction.

### BEST MODE FOR CARRYING OUT THE INVENTION

An embodiment of the present invention will be described below with reference to the accompanying drawings.

Precondition technique 1

In the precondition technique 1, a server serving as an HSM control apparatus according to the present invention will be described.

First, a configuration of an HSM system having the server according to the present invention will be described.

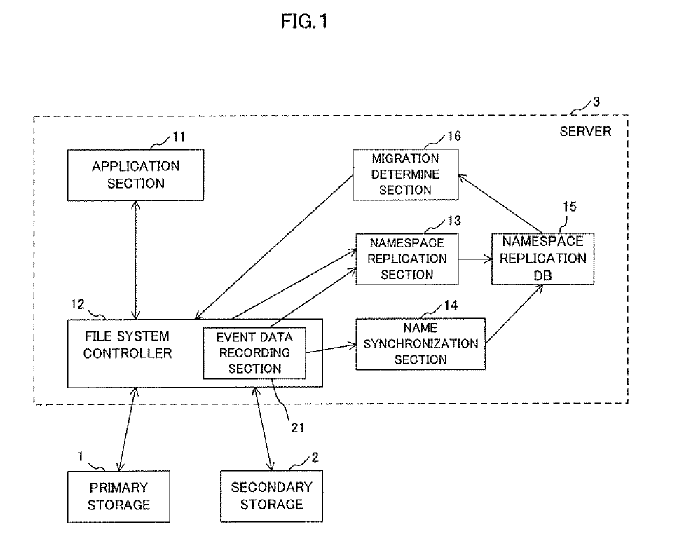

FIG. 1 is a block diagram showing a configuration of the HSM system according to the precondition technique 1. The HSM system includes a primary storage 1 which is a high-speed storage device such as a disk drive storing recently-accessed files, a secondary storage 2 which is a low-speed storage device such as a tape library storing file data which have not been accessed for a long time, and a server 3 which is an HSM control apparatus according to the precondition technique 1, in which an application program for accessing file data is running.

The server 3 includes an application section 11, a file system controller 12, a namespace replication section 13, a name synchronization section 14, a namespace replication DB (Database) 15, and a migration determination section 16. The file system controller 12 includes an event data recording section 21.

Functions of the respective sections constituting the server 3 will next be described.

The event data recording section 21 is a program provided in the file system controller 12 and having a function of storing the history of file operation requests issued by an application program as event data. The event data recording section 21 converts the contents of the file operation requests issued by the application section 11 into a form of event data so as to store them on a memory and, when the amount of the event data reaches a predetermined level, sends them to the namespace replication section 13 and name synchronization section 14. The event data may be sent through a communication line or through use of a dedicated file.

The namespace replication section 13 is a program having a function of replicating the namespace of a file system in parallel to the operation of the application section 11. The namespace replication section 13 traverses the namespace of a file system to acquire the file information of existing files. The namespace replication section 13 combines the acquired file information and event data received from the event data recording section 21 during the file information acquisition process to complete the initial namespace replication in the form of a namespace replication DB 15.

The name synchronization section 14 updates the replication, after the completion of the namespace initial replication, according to the event data received from the event data recording section 21 so as to keep the namespace replication DB 15 up to date. Further, the name synchronization section 14 also plays a role of reflecting notified file access or archive state on the namespace replication DB 15.

The migration determination section 16 is a program having a function of issuing an instruction, as a policy control, to the file system controller 12 in order to send out (migrate) files which have not been accessed for a long time in the primary storage 1 to the secondary storage 2 according to file access records set by the namespace replication section 13 and a policy set by a user. In general, when a given file among the migrated files in the secondary storage 2 is accessed by the application section 11, the accessed file is migrated back to the primary storage 1 (recall) by the file system controller 12. Further, every time a file updated operation is executed, data (archive data) on the secondary storage 2 are invalidated by the file system controller 12. The data on the secondary storage 2 are not erased at this timing but stored as backup data as long as the capacity of the secondary storage 2 is allowed so as to be used to recover from a system failure, if occurring.

Details of the event data, file information, and namespace replication DB 15 will next be described.

First, the event data will be described.

The event data (event) created by the event data recording section 21 represents the content of file operations such as creation/delete of a file or directory, file name change, file access, archive state change. The event data corresponding to each operation includes operation name and time at which an operation corresponding to the operation name is executed, as well as the following data. The term “archive state change” used here includes events such as validation/invalidation of archive data, migration, and recall.

(1) Creation of file or directory

event. rectype=create

event. m_inode#=inode number of parent directory

event. ftype=dir (at mkdir time) or file (at create time)

event. fname=name of created file

event. inode#=inode number of created file or directory

event. time=time when this event occurs

(2) Delete of file or directory

event. rectype=delete

event. m_inode#=inode number of parent directory

event. ftype=dir (at rmdir time) or file (at romove time)

event. inode#=inode number of deleted file or directory

event. time=time when this event occurs

(3) File name change

event. rectype=rename

event. m_inode#=inode number of parent directory

event. ftype=dir (in the case where target is directory) or file (in the case where target is file)

event. inode#=inode number of target file or directory

event. target. m_inode#=inode number of migration destination directory

event. target. fname=name of file or directory after renaming

event. time=time when this event occurs

(4) File access (application program reads/writes file)

event. rectype=access

event. inode#=inode number of file

event. time=time when this event occurs

(5) Archive state change

event. rectype=archive

event. inode#=inode number of file

event. migrate=on (migrated state) or off (recall is activated to release migrated state)

event. archive=on (file data has been written onto secondary storage 2 to validate archive data) or off (file has been updated to invalidate archive data) event. time=time when this event occurs

Next, the file information will be described.

The file information (fstat) acquired from the file system during the name space replication includes the following.

fstat. m_inode#=inode number of parent directory

fstat. ftype=dir (in the case where target is directory) or file (in the case where target is file)

fstat. fname=name of file or directory

fstat. inode#=inode number of file or directory

fstat. archive=on (archive data is valid) or off (archive data is invalid)

fstat. migrate=on (migrated state) or off (non-migrated state)

fstat. atime=time when file was lastly accessed

fstat. time=file information acquisition time

Next, a configuration of the name space replication DB 15 will be described.

The namespace replication DB 15 is a relational database having columns (dbe) shown below, each of which having a tuple for each file element set in a directory or directory element.

dbe. m_inode#=inode number of parent directory

deb. ftype=dir (in the case where this tuple indicates directory) or file (in the case where this tuple indicates file)

dbe. fname=name of file or directory

dbe. inode#=inode number of file or directory

dbe. archive=on (archive data is valid) or off (archive data is invalid)

dbe. migrate=on (migrated state) or off (non-migrated state)

dbe. atime=time when file was lately accessed

dbe. active=on (file information has been acquired) or off (file information has not yet been acquired)

Operation of the server 3 will next be described.

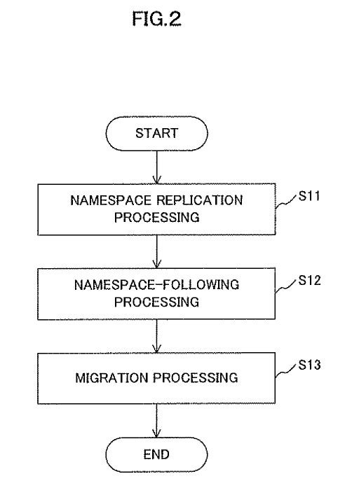

FIG. 2 is a flowchart showing an example of operation of file information acquisition processing according to the precondition technique 1. The server 3 executes namespace replication processing (S11), namespace-following processing (S12), and migration processing (S13).

Details of the operation performed by the server 3 will be described.

First, the namespace replication processing will be described.

The namespace replication processing is performed for creating the initial replication of the namespace and includes file information acquisition processing and event data reflecting processing. Further, the namespace replication processing is performed also for the purpose of re-creating the namespace replication DB 15 at, e.g., the server restart time after occurrence of a failure, where event data stored on the memory have been lost and thereby the content of the namespace DB 15 cannot reflect the latest state of the file system. In such a configuration in which the namespace replication DB 15 is dynamically re-created, it is not necessary to make the event data nonvolatile at the occurrence time of the event but only necessary to store the event data in a small capacity memory, thereby reducing overhead involving the subsequent namespace replication DB-following processing.

As the file information acquisition processing, the namespace replication section 13 opens a parent directory, specifies a child file name or child directory name as an argument, and issues an information acquisition function (getinfo) of the file system, thereby acquiring the file information. Further, the namespace replication section 13 follows the namespace in the ascending (or descending) order of a path name to completely acquire the information of all directories and all files existing in the file system. Since directories or files missed in this process are recorded as event data, correction can be made later.

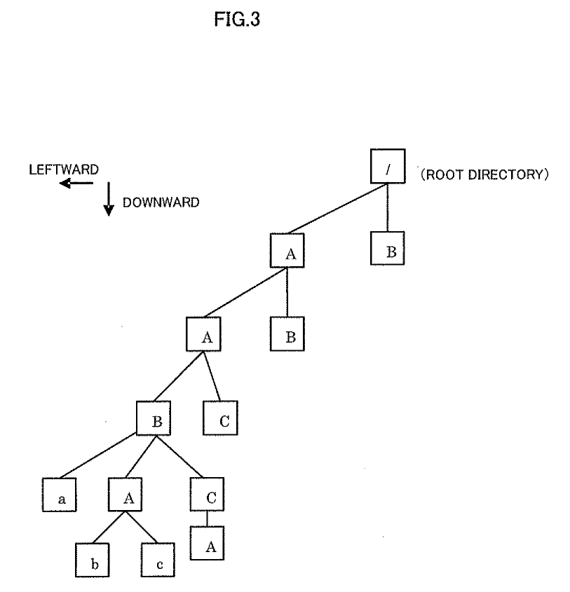

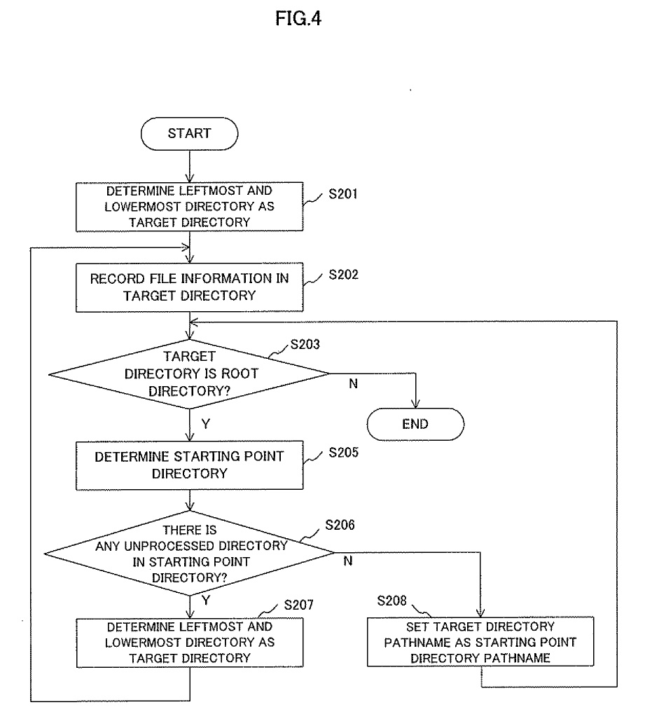

FIG. 3 is a view showing an example of a hierarchical structure of a directory in the namespace. The namespace shown in FIG. 3 is acquired by sorting the names of directories and files in the directory hierarchical structure in the alphanumerically ascending order from left to right. FIG. 4 is a flowchart showing an example of operation of file information acquisition processing according to the precondition technique 1.

The namespace replication section 13 traverses the hierarchical structure in the left downward direction (in the alphanumerically ascending order of directory name) starting from the root directory of the target file system and finds the leftmost and lowermost directory. The namespace replication section 13 then sets the leftmost and lowermost directory as a target directory and sets the pathname of the target directory acquired in the course of the target directory search as a target directory pathname (S201). The namespace replication section 13 then acquires file information of the target directory and file information of all the files in the target directory one by one in the alphanumerically ascending order of the file name and sequentially writes them at the end of a file information recording file (S202). Then, the namespace replication section 13 determines whether the target directory is the root directory or not (S203). When determining that the target directory is the root directory (Y in S203), which means that all files has been processed and therefore the namespace replication section 13 ends this flow.

On the other hand, when determining that the target directory is not the root directory (N in S203), the namespace replication section 13 acquires the pathname of the directory one level above the target directory, that is, sets a path name acquired by removing the last directory name constituting the path name as a new path name. The namespace replication section 13 then searches again the hierarchical structure for the acquired directory path name from the root directory in the downward direction. The last directory whose existence has been confirmed by the search is set as the starting point directory (S205). In the case where a directory in the middle of the path has been migrated to another location in the namespace by rename operation or the like, the migrated directory cannot be found in the course of the search. However, the missed portion will be found in the subsequent file information acquisition processing or recorded in the event data and, therefore, the namespace will surely be corrected later. Thus, the missed portion can be ignored at this time point.

Then, the namespace replication section 13 reads the content of the starting point directory and determines whether there is any unprocessed directory in the starting point directory or not (S206). If there are unprocessed directories (S206, Y), the namespace replication section 13 searches for an leftmost and lowermost unprocessed directory and sets this directory as a target directory (S207), proceeding to the processing S202. If there are no unprocessed directories, that is, if there are no directories having a name alphanumerically higher than one indicated by a target directory path name in the starting directory (S206, N), the namespace replication section 13 sets the target directory path name as the path name of the starting point directory (S208), proceeding to the processing S203.

After completion of the file information acquisition processing for the target file system, the namespace replication section 13 performs event data reflection processing of reflecting event data generated during the information acquisition processing on the file information. In the event data reflection processing, the namespace replication section 13 sequentially reads the content of the file information recording files from the beginning to process all the file information recorded in the file information recording file.

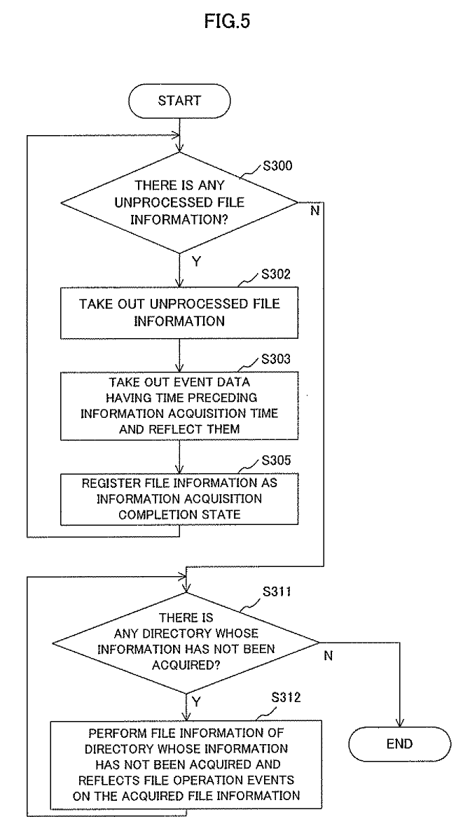

FIG. 5 is a flowchart showing an example of operation of the event data reflection processing according to the precondition technique 1. The namespace replication section 13 takes out unprocessed file information (S302) and then sequentially takes out event data having the time preceding the information acquisition time set in the file information and reflects them on the namespace replication DB 15 (S303).

Hereinafter, the reflection of event data on the namespace replication DB 15 will be described for each file operation type (file delete, file creation, file name change, file access, and archive state change).

In the case where the event data represents the file delete type operation (file delete or directory delete), the namespace replication section 13 deletes a delete target file or directory if it has been registered in the namespace replication DB 15 and ignores this event data if not registered. Here, in the case where there exists an entry that satisfies the following all conditions, the corresponding file or directory is regarded as being registered.

dbe. inode# == event. inode#
dbe. m_inode# == event. m_inode#
dbe. fname == event. fname

In the case where the event data represents the file creation type operation (file creation or directory creation), the namespace replication section 13 registers a created file or directory if it has not been registered in the namespace replication DB 15 and ignores this event data as “information acquisition completion state” if registered. In the case where there exists an entry that satisfies the following all conditions, the corresponding file or directory is regarded as being registered.

dbe. inode# == event. inode#
dbe. m_inode# == event. m_inode#
dbe. fname == event. fname

The content set at the time when the target file or directory has not been registered is shown below.

dbe. m_inode# = event. m_inode#
dbe. ftype = event. ftype
dbe. fname = event. fname
dbe. inode# = event. inode#
dbe. archive = off
dbe. migrate = off
dbe. atime = event. time
dbe.active = on

In the case where the event data represents the file name change (event. rectype == rename) type operation, the namespace replication section 13 processes this event in the following procedure. In the case where a file or directory having the same name as one acquired after rename processing has been registered (evaluated by file name and parent inode number), the namespace replication section 13 deletes the corresponding entry from the namespace replication DB 15. In the case where there exists an entry that satisfies the following all conditions, the corresponding file or directory is regarded as being registered.

dbe. name == event. target. fname
dbe. m_inode# == event. target. m_inode#
dbe. fname == event. fname

In the case where a target file has been registered in the namespace replication DB 15, the namespace replication section 13 changes the parent information and file name of the corresponding entry. In the case where there exists an entry that satisfies the following all conditions, the corresponding file is regarded as being registered.

dbe. inode# == event. inode#
dbe. m_inode# == event. m_inode#
dbe. fname == event. fname

The content to be changed at this time is shown below.

dbe. m_inode# = event. target. m_inode#
dbe. name = event. target. fname

In the case where a target file has not been registered in the namespace replication DB 15, the namespace replication section 13 registers a renamed file in the namespace replication DB 15 as a new entry.

dbe. inode# = event. inode#
dbe. m_inode# = event. target. m_inode#
dbe. name = event.target.fname
dbe. active = off

In the case where the event data represents the file access (event. rectype == access), the namespace replication section 13 ignores this event data if the target inode has not been registered. Otherwise, the namespace replication section 13 updates (since there exist “hard links”) the file access last time, archive information, and recall information of all registered entries. In the case where there exists an entry that satisfies the following all conditions, the corresponding inode is regarded as being registered.

dbe. inode#== event. inode#

The content to be changed at this time is shown below.

dbe. atime=event. time

In the case where the event data represents the archive state change (event. rectype == archive), the namespace replication section 13 ignores this event data if the target inode has not been registered. Otherwise, the namespace replication section 13 updates (since there exist “hard links”) the archive information of all registered entries. In the case where there exists an entry that satisfies the following all conditions, the corresponding inode is regarded as being registered.

dbe. inode#== event. inode#

The content to be changed at this time is shown below.

dbe. archive = event. archive
dbe. migrate = event. migrate

Then, the namespace replication section 13 registers the content of the file information in the namespace replication DB 15 if it not registered therein as “information acquisition completion state” (S305). In the case where there registered the tuples having the same inode number, the namespace replication section 13 changes the content of all the registered entries. In the case where there exists an entry that satisfies the following all conditions, the corresponding file information is regarded as being registered.

dbe. inode# == fstat. inode#
dbe. fname == fstat. fname
dbe. m_inode# == fstat. m_inode#

The content of a new entry set, in the case where there exists no corresponding entry, is shown below.

dbe. m_inode# = fstat. m_inode#
dbe. ftype = fstat. ftype
dbe. fname = fstat. fname
dbe. inode# = fstat. inode#
dbe. archive = fstat. archive
dbe. migrate = fstat. migrate
dbe. atime = fstat. atime
dbe. active = on

The content set in the case where the same inode number has been registered (i.e., dbe. inode#=fstat. inode#) is shown below.

dbe. archive = fstat. archive
dbe. migrate = fstat. migrate
dbe. atime = fstat. atime
dbe. active = on

When processing of all recorded file information has been completed, the namespace replication section 13 determines whether any segment (directory whose information has not been acquired) of the namespace that has been missed in the information acquisition processing due to processing conflict with the file operation that changes the namespace exists or not (S311). When determining that there is no directory whose information has not been acquired (N in S311), the namespace replication section 13 ends this flow. On the other hand, when determining that any directory whose information has not been acquired exists (Y in S311), the namespace replication section 13 performs the file information acquisition processing with the relevant directory set as a root, reflects events data that has occurred during the above file information acquisition processing on the acquired file information events (S312) and returns to step S311, where the namespace replication section 13 repeats the above processing for another directory whose information has not been acquired.

The namespace-following processing will next be described.

The name synchronization section 14 receives event data generated after completion of the namespace replication processing from the event data recording section 21 and sequentially reflects the event data on the namespace replication DB 15. The event data reflection processing is almost the same as the namespace replication processing except that it does not use file information and, therefore, becomes correspondingly simpler than the namespace replication processing.

In the case where the event data represents the file delete type operation event (file delete or directory delete), the name synchronization section 14 deletes the entry including all of the inode number, parent inode number, and file name indicated by the event data from the namespace replication DB 15.

In the case where the event data represents the file creation type operation (file creation or directory creation), the name synchronization section 14 registers the entry including the inode number indicated by the event data in the namespace replication DB 15 and sets the attribute (type) and parent inode number notified by the event data.

In the case where the event data represents the file name change (rename) type operation, when a file having the same name as a target one, the name synchronization section 14 deletes it. Further, the name synchronization section 14 changes the parent attribute of the source.

In the case where the event data represents the file access event, the name synchronization section 14 identifies the access time notified by the event data with the inode number and sets it in the namespace replication DB 15.

In the case where the event data represents the archive state change, the name synchronization section 14 updates the archive information.

The migration processing will next be described.

The migration determination section 16 uses a command or the like provided by the file system to periodically check the available amount of free space in the primary storage 1. When the available amount of free space becomes less than the value specified by a user, the migration determination section 16 uses the information set in the namespace replication DB 15 to determine a migration target file and requires the file system controller 12 to perform migration processing. At this time, the migration determination section 16 delivers the path name of a file acquired from the namespace replication DB 15 to the file system controller 12 so that the file system controller 12 writes the path name and corresponding file data in the secondary storage 2. The migrate determination processing can be performed in various manner according to a user policy, and the following is an example thereof.

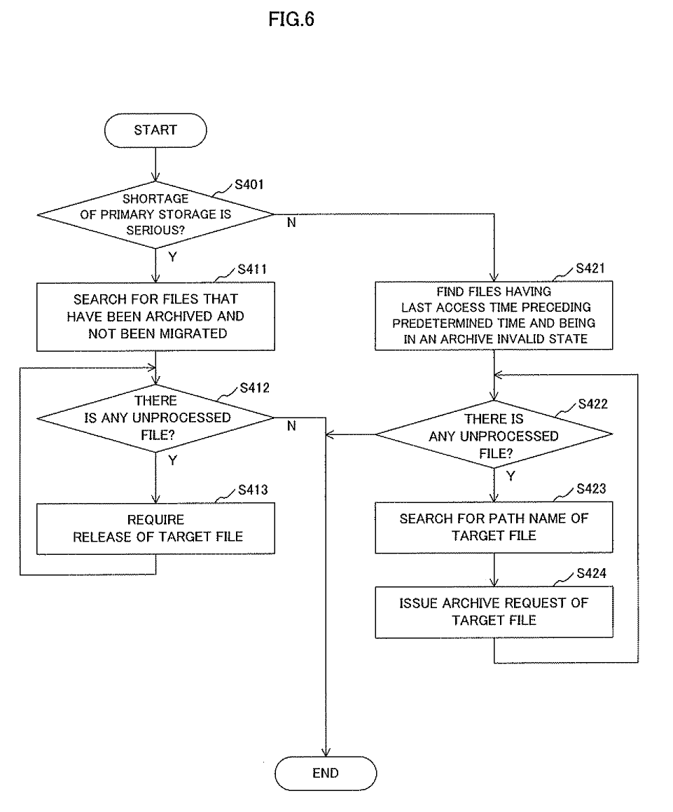

FIG. 6 is a flowchart showing an example of operation of the migration determination processing according to the precondition technique 1. The migration determination section 16 determines whether shortage of the primary storage 1 is critical or not (S401).

In the case where shortage of the primary storage 1 is critical (Y in S401), the migration determination section 16 searches the namespace replication DB 15 to find files that have been archived and not been migrated (S411) and performs the following release processing (release of the primary storage area) for all the found files. Then, the migration determination section 16 determines whether there is any unprocessed file among the found files (S412).

In the case where there is no unprocessed file (N in S412), the migration determination section 16 ends this flow. On the other hand, in the case where there is any unprocessed file (Y in S412), the migration determination section 16 requires the file system controller 12 to perform release of the primary storage, i.e., release the target file using the inode number set in the namespace replication DB 15 as an argument (S413). Then, upon receipt of a reply from the file system controller 12, the migration determination section 16 returns to step S412, where it performs processing for the next file.

Since the namespace replication DB 15 lags behind the file system, there may be case where a target file has actually been modified, that is archive state in the namespace replication DB 15 has been invalid, and respond to the migration determination section 16. In such a case, the file system controller 12 returns an error reply. In the case where a target file has been in an archived state, the file system controller 12 releases the primary storage area that has been allocated for storing the file and returns a normal reply.

On the other hand, in the case where the shortage of the primary storage 1 is not critical (N in S401), the migration determination section 16 archives files that have not been accessed for a given time period so as to immediately cope with a critical shortage, if it occurs. To this end, the migration determination section 16 searches the namespace replication DB 15 so as to find files having the last access time preceding a predetermined time (e.g., current time minus one day) and being in an archive invalid state (files that have not been archived) (S421). Subsequently, the migration determination section 16 determines whether there is any unprocessed file in the found files (S422).

In the case where there is no unprocessed file (N in S422), the migration determination section 16 ends this flow. On the other hand, in the case where there is any unprocessed file (Y in S422), the migration determination section 16 uses the parent inode number set in the namespace replication DB 15 as a key to repeatedly search the namespace replication DB 15 to find the path names of the unprocessed files (S423). Then, the migration determination section 16 issues an archive request together with the inode number and file path name as arguments to the file system controller 12 (S424). Upon reception of the request, the file system controller 12 collectively writes the data, file path name, and inode number of a specified file on the secondary storage and returns to step S422 where it performs processing for the next target file, If, in step S424, the requested file no longer exists, the file system controller 12 returns an error reply to the migration determination section 16 and ignores the request.

A description will be made of operation of the other sections.

First, operation of the file system controller 12 will be described.

When receiving a release request from the migration determination section 16, the file system controller 12 performs the release request and, if copies of target file data exist (have been archived) in the secondary storage, releases the primary storage, thereby setting the target files in a migrated state. At this time, the event data recording section 21 creates an archive state change event as follows.

event. rectype = archive
event. archive = on
event. migrate = on

When receiving a archive request from the migration determination section 16, the file system controller 12 performs the release request, starts writing file data on the secondary storage 2, and returns processing control to the migration determination section 16. At this writing time, the file system controller 12 adds the file path name notified from the migration determination section 16 to the header section of the data to be written. After the completion of the writing to the secondary storage 2, the event data recording section 21 creates an archive state change event as follows.

event. rectype = archive
event. archive = on
event. migrate = off

In the case where the application section 11 tries to access the migrated file, the file system controller 12 allocates a new area on the primary storage 1 at that timing when the application section 11 tries to access the migrated file and reads the target data on the secondary storage 2 in that area. After that, the event data recording section 21 creates an archive state change event representing completion of the recall as follows.

event. rectype = archive
event. archive = on
event. migrate = off

In the case where the application section 11 requests file operation (file creation/delete, directory creation/delete, file read/write), the file system controller 12 processes the request After the file system controller 12 has normally processed the request, the event data recording section 21 creates a corresponding event data.

In the case where the file information is required from the namespace replication section 13 using getinfo, the file system controller 12 confirms that the specified file exists in the parent directory and returns the file information of the specified file. If the specified file does not exist, the file system controller 12 returns an error reply. When receiving the error reply, the namespace replication section 13 determines that the specified file has not existed and shifts to the subsequent processing.

Operation of the event data recording section 21 will next be described.

The event data recording section 21 exists in the file system controller 12 and has a function of creating event data at the timing described in the explanation for the operation of the file system controller 12 and stores it in a memory. Further, the event data recording section 21 collectively notifies the name synchronization section 14 or namespace replication section 13 of the event data stored in a memory when the amount of the event data on the memory becomes greater than a certain value or after a certain time period has elapsed from the previous notification. Further, also when the system is normally terminated, the event data recording section 21 performs system termination processing to notify the name synchronization section 14 of the event data stored therein to thereby allow the name synchronization section 14 to reflect all the event data on the namespace replication DB 15.

Further, in order to reduce the amount of data to be notified, the event data recording section 21 performs optimization as follows. In the case where the event data recording section 21 creates a file access event, when a file access event for the same file is included in unnotified event data on the memory, the event data recording section 21 discards the succeeding file access events, that is, does not store them in the memory. In the case where the event data recording section 21 is required to create a file delete event, when a corresponding file creation event is included as unnotified event data, the event data recording section 21 invalidates the file creation event on the memory to exclude it from the object to be notified.

Next, system start-up processing in the server 3 will be described.

When the system is normally terminated, the name synchronization section 14 performs normal termination processing to collectively reflect the event data on the memory on the namespace replication DB 15 as described above, so that it is not necessary to make the namespace replication section 13 work at the next start-up time. On the other hand, in the case where any failure has occurred, the namespace replication section 13 is activated to perform start-up processing after system abnormal termination to resynchronize the namespace replication DB 15 with the actual name space in the primary storage. Since the namespace information immediately before the failure remains even in such a case, when a migration target needs to be determined until the re-initialization of the namespace replication is completed, the migration determination section can continue processing using the data stored in the namespace replication DB 15.

Although the migration determination section 16 performs the policy control based on the namespace replication DB 15 in the present embodiment, another configuration of a policy control in the HSM control may be performed based on the namespace replication DB 15.

In the precondition technique 1, since too much load is applied to the file system controller 12 if an event notification is made to the name synchronization section 14 from the file system controller 12 for each updated namespace, the file system controller 12 makes event notifications collectively after a certain number of events have been accumulated. However, if events accumulated in the file system controller 12 have been lost due to communication failures or a crashed system file controller 12, the namespace replication section 13 destroys the previous contents of the namespace replication DB 15 once and performs an entire namespace search processing for scanning the entire namespace in the primary storage 1 to perform a replication again from the beginning. Here, even if the number of lost events is small, the load of the entire namespace search processing is large.

In the entire namespace search processing, the namespace is scanned in sequence from the deepest point. Moreover, if an update event of the namespace is notified in the process of a namespace replication DB restoration processing, the namespace replication section 13 rescans a tree including updated points in the namespace. Thus, if the namespace is updated frequently, the termination of the entire namespace search processing is delayed. Particularly, if the file system is huge, the namespace replication DB restoration processing may not be sometimes terminated.

Now, embodiments of the present invention will be described with reference to the drawings.

### First Embodiment

In the present embodiment, there will be described a HSM system for correcting the namespace replication DB efficiently if any event from a FS (File System) control server (file system controller) has been lost in the HSM system creating and updating the namespace replication DB as in the precondition technique 1.

First, a configuration of the HSM system according to the present embodiment will be described.

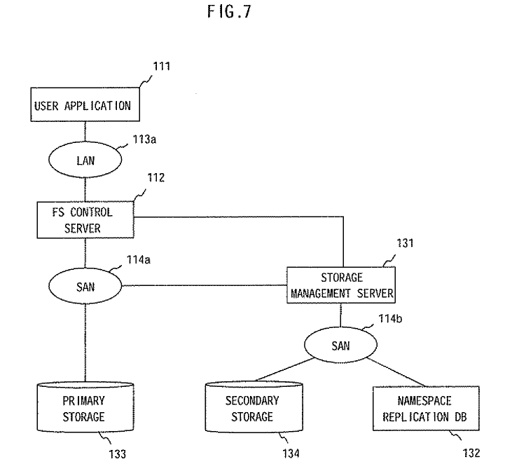

FIG. 7 is a block diagram showing an example of a configuration of the HSM system according to the present embodiment. This HSM system includes a user application 111, a FS control server 112, a storage management server 131, a namespace replication DB 132, a primary storage 133, and a secondary storage 134. The user application 111 and the FS control server 112 are connected via a LAN (Local Area Network) 113a with each other. The FS control server 112 and the storage management server 131 are connected with each other. Moreover, the FS control server 112, the storage management server 131, and the primary storage 133 are connected via a SAN (Storage Area Network) 114a with each other. The storage management server 131, the secondary storage 134, and the namespace replication DB 132 are connected via a SAN 114b with each other.

FIG. 8 is a block diagram showing an example of detailed configuration and operation of the HSM system according to the present embodiment. Here, the FS control server 112 includes an AC (Access Client) 121, a MDS (Meta Data Server) 122, and a HSMA (HSM Agent) 123. The MDS 122 includes an event queue 124. In addition, the primary storage 133 in the present embodiment corresponds to the primary storage 1 in the precondition technique 1. The secondary storage 134 in the present embodiment corresponds to the secondary storage 2 in the precondition technique 1. The user application 111 in the present embodiment corresponds to the application section 11 in the precondition technique 1. The FS control server 112 in the present embodiment corresponds to the file system controller 12 in the precondition technique 1. The storage management server 131 in the present embodiment corresponds to the namespace replication section 13, the name synchronization section 14, and the migration determination section 16 in the precondition technique 1. The namespace replication DB 132 in the present embodiment corresponds to the namespace replication DB 15 in the precondition technique 1.

The AC 121 receives requests from the user application 111. The MDS 122 manages meta data (namespace, extent information, inode information, etc.) in the primary storage 133 collectively in addition to carrying out an server function of inter-node exclusive token. The HSMA 123 is an agent process mediating requests from the storage management server 131 to the FS control server 112. The storage management server 131 has a data copy function between the first storage 133 and the second storage 134, a device control function such as a free space control for both the storages, and a policy control function for the file system and the storages.

The first storage 133 stores a file 142 and a DB maintenance flag (database maintenance information) 143. The DR maintenance flag 143 is set in a super block at the head of the disk for the first storage 133. The second storage stores an archive file 144. Moreover, the namespace replication DB 132 stores a namespace table 151 and an archive ID table 152.

Next, a namespace-following processing will be described using the sequence in FIG. 8.

Here, as a namespace replication mode representing operations to the namespace replication DB 132, there are an event notification mode in which a namespace-following processing is performed during normal operation and a correction command mode in which a namespace replication DB correction processing is performed in a case of lost events. The namespace-following processing is similar to that in the precondition technique 1 and is a processing for updating the namespace replication DB 132 in response to an event notification from the FS control server 112 after the storage management server 131 has replicated the namespace replication DB 132. The namespace replication DB correction processing is a processing for correcting the namespace replication DB 132 by causing the storage management server 131 to request necessary information from the FS control server 112.

First, when a request for updating the namespace (mkdir, rename, rmdir, etc.) is generated, the user application 111 sends this request to the FS control server 112 (S511). Then, the AC 121 sends the received request to the MDS 122 (S512). Then, the MDS 122 updates the namespace in the primary storage 133 according to the received request (S513) and accumulates the update content reflected on the primary storage 133 in the event queue 124 as an event (namespace update information: namespace transition event or archive disabling event). After a predetermined time has elapsed, the MDS 122 sends the events accumulated in the event queue 124 to the storage management server 131 as a posterior event-asynchronous notification (S514). Then, the storage management server 131 updates the namespace replication DB 132 according to the received posterior event-asynchronous notification (S515).

When archiving files based upon a predetermined policy or the instruction of the manager, the storage management server 131 sends a flash request of the events accumulated in the MDS 122 to the FS control server 112 (S521). Then, the HSMA 123 sends the received request to the AC 121 (S522). Then, the AC121 sends the received request to the MDS 122 (S523). Then, the MDS 122 sends the events accumulated in the event queue 124 to the storage management server 131 as a posterior event-asynchronous notification according to the received request (S524).

Then, the storage management server 131 updates the namespace replication DB 132 according to the received posterior event-asynchronous notification (S525), searches an archive target file from the updated namespace replication DB 132 by executing a processing similar to one performed by the migration determination section 16 in the precondition technique 1 (S526), and sends an archive request of the determined archive target file to the FS control server 112 (S531). Then, the HSMA 123 sends the received request to the AC 121 (S532). Then, the AC 121 sends the received request to the MDS 122 (S533). Then, the MDS 122 updates the meta data according to the received request and notifies the storage management server 131 of the result of the update (S534). Then, the storage management server 131 creates an archive in the secondary storage 134 (S535).

Next, a namespace replication mode determination processing for determining the namespace replication mode will be described.

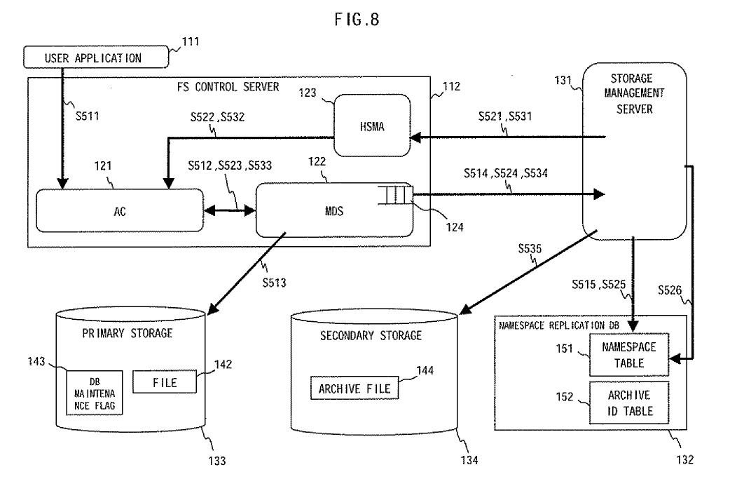

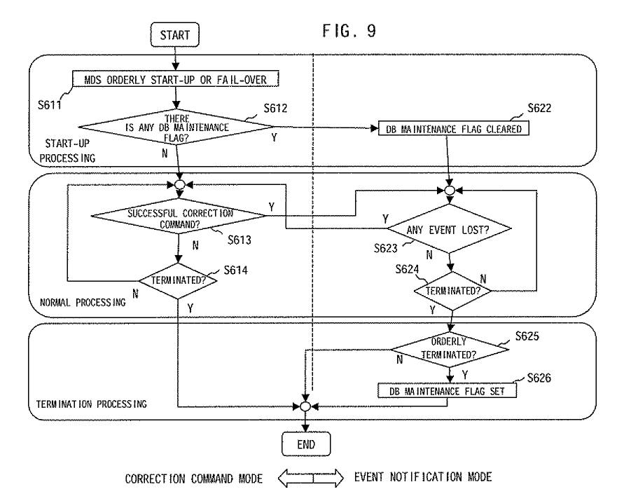

FIG. 9 is a flowchart showing an example of operation of a namespace replication mode determination processing according to the present embodiment. The left half of this flowchart illustrates a correction command mode and the right half thereof illustrates an event notification mode. Moreover, if being set, the DB maintenance flag 143 indicates that no namespace replication DB correction processing is required.

First, the MDS 122 starts orderly or in fail-over (S611). At this time, the namespace replication mode is a correction command mode. Then, the MDS 122 determines whether the DB maintenance flag 143 in the primary storage 133 is set or not (S612).

When the DB maintenance flag 143 is set (S612, Y), the MDs 122 changes the namespace replication mode from the correction command mode to the event notification mode and clears the DB maintenance flag 143 once (S622) to perform a normal processing. If no lost event is detected (S623, N) and no termination request is issued in the process of the normal processing, the MDS 122 continues the normal processing. If a termination request is issued (S624, Y), the MDS 122 performs a termination processing. If determined that this termination processing can be completed orderly (S625, Y), the DB maintenance flag 143 is set during the processing (S626) to terminate this flow. As a result of this setting of the DB maintenance flag 143, the start-up of the MDS 122 is recognized as an orderly start-up.

If any lost event has been detected during the normal processing (S623, Y), the MDS 122 changes the namespace replication mode from the event notification mode to the correction command mode and sends a correction command to the storage management server 131, thereby causing the storage management server 131 to perform the namespace replication DB correction processing.

If the DB maintenance flag 143 has been cleared in the processing S612 (S612, N), the MDS 122 sends a correction command to the storage management server 131, thereby causing the storage management server 131 to perform the namespace replication DB correction processing. If no termination request is issued (S614, N) when waiting for a response to the correction command (S613, Y), the MDS 122 continues to wait for a response. Moreover, If any termination request is issued (S614, Y) when waiting for a response to the correction command (S613, Y), the MDS 122 performs a termination processing to terminate this flow. When having received a normal response to the correction command (S613, Y), the MDS 122 changes the namespace replication mode from the correction command mode to the event notification mode to perform a normal processing.

Next, a data structure relating to the namespace will be described.

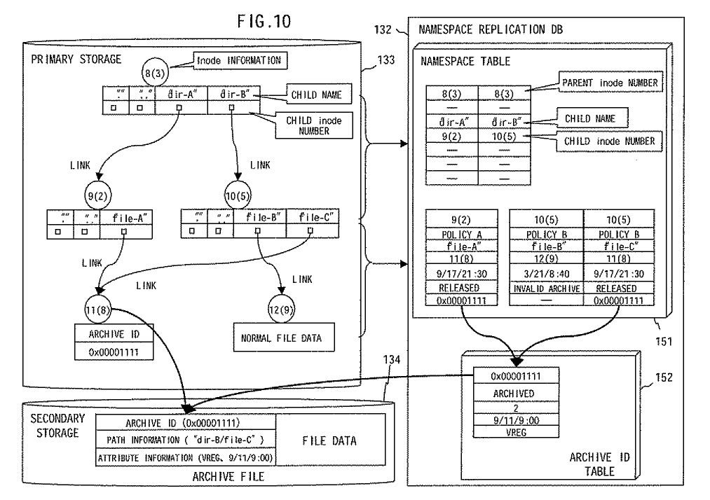

FIG. 10 is a block diagram showing an example of the data structure relating to the namespace according to the present embodiment. This figure illustrates the data structure of the primary storage 133, secondary storage 134, and namespace replication DB 132.

In the primary storage 133, each file comprises inode information (represented by a circle within the primary storage 133 in the figure) and file data (represented by a square within the primary storage 133 in the figure). The inode information comprises an inode number, a gen number, an attribute, and time information. The gen (generation) number is a number used to identify files having identical inode numbers by generations and is used in the NFS (Network File System) and the HSM. The attribute is information showing whether a certain file is a directory file or a regular file. The time information comprises mtime (data update time), ctime (inode update time), and atime (access time). When the inode information is updated, ctime is also updated.

The files in the primary storage 133 comprise directory files and regular files. The file data for each of the directory files in the primary storage 133 contains link information for each of links to child files. The link information comprises the name of one child file and inode number. The file data for each of the regular files in the primary storage 133 comprises regular file data or an archive ID.

Under the directory file having an inode number=8, there exist a directory file having an inode number=9 and a directory file having an inode number 10. Under the directory file having an inode number=9, there exists a regular file having an inode number=11. Under the directory file having an inode number=10, there exists a regular file having an inode number=12.

Each of the directory files having inode numbers=8, 9, 10 contains a parent inode number, a child name, and a child inode number. The regular file having an inode number=11 is linked to both directories having an inode number=9 and an inode number=10 and is archived in the secondary storage 134, thereby containing an archive ID as file data. The regular file having an inode number=12 contains regular file data as file data.

The namespace table 151 for the namespace replication DB 132 is one created by representing the namespace for the primary storage 133 with a database, in which entries are created for each of the links in the primary storage 133 and are saved collectively for each of the parent directory files. The entry of the link, in which the parent is a directory file and the children are directory files (the parent has an inode number=8 and one child has an inode number=9; and the parent has an inode number=8 and another child has an inode number=10), contains a parent inode number (gen number), children names, and children inode numbers (gen numbers).

Moreover, the entry of the link, in which the parent is a directory file and the children are regular files (the parent has an inode number=9 and one child has an inode number=11; the parent has an inode number=10 and another child has an inode number=12; and the parent has an inode number=10 and one child has an inode number=11), contains detailed information about child files such as parent inode numbers (gen numbers), policy ID, child names, child inode numbers, child last access times, child state values in the policy control, and child archive IDs.

The archive ID table 152 for the namespace replication DB 132 manages archive IDs corresponding to logical positions on the secondary storage 134, creating an entry for each of the files. The entry contains an archive ID, an archive data state value, a recall ID, the last data update time, and information for inode information creation at the time of restoration.

The secondary storage 134 contains an archive ID, path information, attribute information, and file data for each of the archive files. The path information in this example is one archived by policy B.

Next, the types and contents of events will be described.

FIG. 11 is a table showing an example of types and contents of events according to the present embodiment. The types of events notified from the FS control server 112 to the storage management server 131 include name insertion, name deletion, name change, and inode information change.

The name insertion means a meta data processing accompanied by name insertion into a directory, that is, that link information such as child file names, and inode numbers is inserted into the parent directory file. The name deletion means a meta data processing accompanied by name deletion from a directory, that is, that link information is deleted from the parent directory file. The name change means a meta data processing accompanied by name change with or without spanning a directory, that is, that link information is transferred. The inode information change means a meta data processing accompanied by inode information change without link information change, that is, that mtime of inode information has been changed due to a write operation applied to a certain file.

Next, the types of event-added information added as the contents of an event (namespace change contents) include a parent inode number (No. 1), a parent inode number (No. 2), a target file name (No. 1), a target file name (No. 2), child inode information, and event generation time (namespace change time). Among these event-added information, the parent inode number (No. 1), the parent inode number (No. 2), and the child inode information contain inode/gen numbers, ctime/mtime/atime, extent information, etc.

This table is composed of event type columns and event-added information rows. If any event-added information, which is a content of a certain event type, is contained, “◯” is marked in an intersection field. The name insertion and name deletion include a parent inode number (No. 1), a target file name (No. 1), child inode information, and event generation times. The name change includes a parent inode number (No. 1), a parent inode number (No. 2), a target file name (No. 1), a target file name (No. 2), child inode information, and event generation times. The inode information change includes child inode information and event generation times.

Only the event-added information in the name change includes two parent inode numbers and two target file names. The parent inode number (No. 1) and the target file name (No. 1) show status before name change, and the parent inode number (No. 2) and the target file name (No. 2) show status after name change. Moreover, the child inode information and the event generation time are added to all the events.

In addition, there is a correction command which is notified like events from the FS control server 112 to the storage management server 131. The correction command is generated by the namespace replication mode determination processing.

Next, a namespace replication DB correction processing will be described.

When inode information is updated in the file system for the primary storage 133, ctime of the inode information is always updated. When link information is updated, inode information at both ends of the link is updated, thereby updating ctime of the inode information. On the other hand, as described above, in the normal processing, the FS control server 112 notifies event generation times together with the contents of the events to the storage management server 131. The storage management server 131 stores the last event generation time reflected on the namespace replication DB 132 as the last event generation time.

Accordingly, the storage management server 131 has only to correct the namespace replication DB 132 by using inode information containing ctime later than the last event generation time and link information from the inode information to a child. Here, taking this small time delay into consideration, the storage management server 131 uses inode information containing ctime which is not “later than the last event generation time”, but “earlier than the last event generation time”.

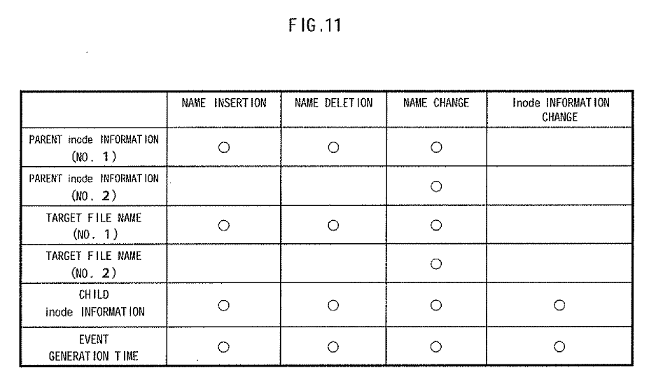

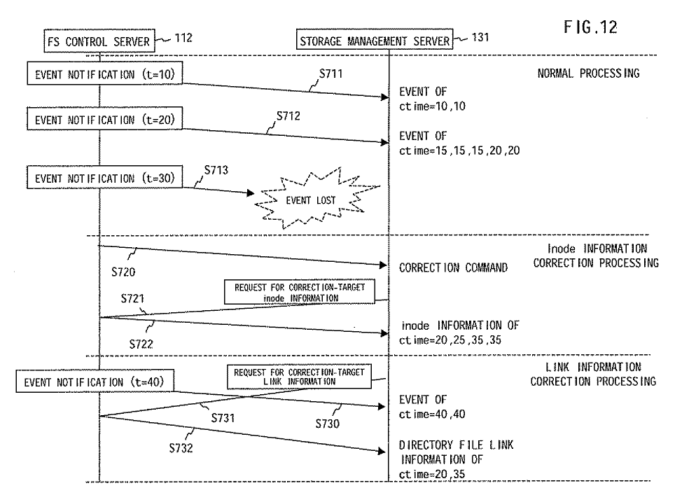

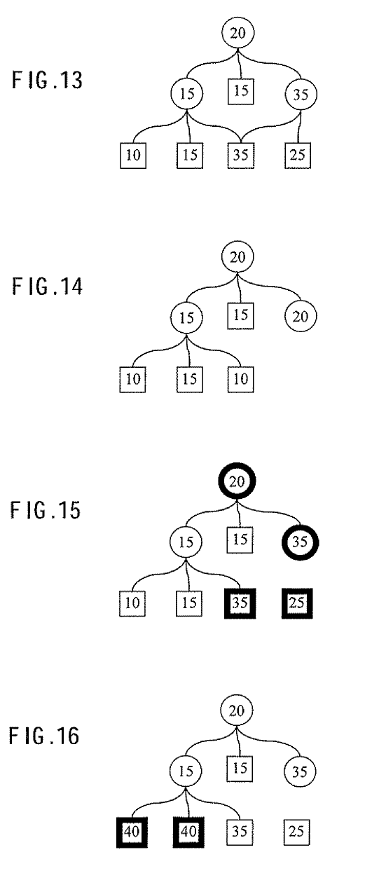

Now, the namespace replication DB correction processing will be described with reference to an illustrative example. FIG. 12 is a sequence diagram showing an example of operation of namespace DB correction processing according to the present embodiment. This figure shows the operations of the FS control server 112 and the storage management server 131. Moreover, FIG. 13 is a tree-structured diagram showing an example of the content of a namespace in a primary storage at the time of event loss. Each node represents inode information for each file. Among these nodes, the ones represented by a circle correspond to inode information in the directory file, and the ones represented by a square correspond to inode information in the regular file. The numbers inscribed in the nodes represent ctime values in inode information. The lines connecting the nodes with each other represent link information.

First, as a normal processing, the FS control server 112 makes an event notification of time t=10 (S711), an event notification of time t=20 (S712), and an event notification of time t=30 (S713). In this illustrative example, an event of ctime=10, 10 is notified at t=10, and an event of ctime=15, 15, 15, 20, 20 is notified at t=20. Moreover, it is assumed that an event notification at t=30 has not reached the storage management server 131 due to communication failure. FIG. 14 is a tree-structured diagram showing an example of the content of a namespace table at the time of event loss. Compared with the namespace for the primary storage 133, inode information and link information after ctime=20 are missing in the namespace table.

Thereafter, when a correction command is notified as a result of the namespace replication mode determination processing by the FS control server 112 (S720), the storage management server 131 sends a request for inode information of ctime=20 and more (unupdated inode information) to the FS control server 112 as an inode information correction processing for correcting inode information in the namespace replication DB 132 (S721). In response to this request, the FS control server 112 enumerates inode information of ctime=20 and more, sending the enumerated inode information as target inode information to the storage management server 131 (S722). In this illustrative example, inode information of ctime=20, 25, 35, 35 is sent to the storage management server 131.

The storage management server 131 corrects a namespace table 151 using the received target inode information. FIG. 15 is a tree-structured diagram showing an example of the content of a namespace table at the time of inode information correction. The nodes enclosed with thick frame borders correspond to the corrected inode information. The other nodes correspond to the status quo inode information. At this moment, the namespace table 151 allows the existence of inode information to which no link information is provided.

Here, when a new event is notified from the FS control server 112 to the storage management server 131, the storage management server 131 determines whether the notified event has some relationship to the already corrected inode information or not, and if not reflects the event on the namespace table 151 as needed. FIG. 16 is a tree-structured diagram showing an example of the content of a namespace table at the time if an event having no relationship to the corrected inode information was reflected. The nodes enclosed with thick frame borders correspond to the inode information on which an event having no relationship to the corrected inode information is reflected.

Next, the storage management server 131 extracts the inode information of the directory file from the corrected inode information as a link information correction processing for correcting link information in the namespace replication DB 132, sending a request (unupdated link information request) for link information contained in the extracted directory file (unupdated link information) to the FS control server 112 (S731). In response to this request, the FS control server 112 enumerates unupdated link information, sending the enumerated unupdated link information to the storage management server 131 (S732). At this time, the FS control server 112 also sends the inode information of child files shown in the unupdated link information together with the unupdated link information. In this illustrative example, link information corresponding to directory file inode information of ctime=20, 35 is sent to the storage management server 131.

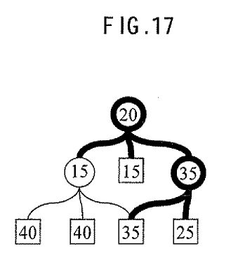

The storage management server 131 corrects the link information in the namespace table 151 based upon the received unupdated link information, terminating the namespace replication DB correction processing. FIG. 17 is a tree-structured diagram showing an example of the content of a namespace table at the time of link information correction. The nodes enclosed with thick frame borders correspond to the directory file inode information in the corrected inode information, and the link information represented with thick lines correspond to the corrected link information.

In the processing S730, a case where a new event has no relationship to the corrected inode information is described. However, in a case where a new event has some relationship to the corrected inode information, ctime of the related inode information is compared with the event generation time of the new event to correct inode information and link information by using the newer information.

As described above, the storage management server 131 replicates the namespace as the namespace table 151 which is a database having an entry for each link information. According to this namespace table 151, different from the normal namespace in which the tree structure must be always complete, correction from an incomplete tree structure can be facilitated.

In the precondition technique 1, the entire tree of the namespace is scanned at the time of event loss to recreate the namespace replication DB, and the tree relating to each newly generated event is scanned to correct the namespace replication DB. In contrast thereto, according to the present embodiment, the storage management server 131 corrects the namespace replication DB 132 at the time of event loss by using only unupdated inode information and unupdated link information which are not reflected on the namespace replication DB 132, thereby allowing the namespace replication DB 132 to be corrected under low load and at high speed. Moreover, even if a new event is notified during correction of the namespace replication DB 132, the storage management server 131 reflects the newer one of the event and the unupdated inode information on the namespace replication DB, thereby allowing the namespace replication DB 132 to be updated under low load and at high speed. Accordingly, the namespace can be replicated even in a huge file system.

The namespace replication device according to the present embodiment can be easily applied to a storage system, allowing the performance of the storage system to be improved. Here, the storage system can include, for example, a HSM system, a backup system, etc.

In addition, a program for causing each of the above-described steps to be executed on a computer composing the namespace replication device can be provided as a namespace replication program. The program is stored in a computer-readable record medium, thereby allowing it to be executed by a computer composing the namespace replication device. Here, the computer-readable record medium includes internal memories implemented internally in a computer such as ROM, RAM, etc., portable memory media such as CD-ROM, flexible disk, DVD disk, magnetic optical disk, IC card, etc., databases maintaining computer programs, other computers and databases thereof, as well as line transmission media.

Further, the storage device corresponds to the primary storage in the embodiment. The file system controller corresponds to the FS control server in the embodiment.

Moreover, the namespace replication database update step corresponds to the namespace-following processing in the embodiment. The namespace replication database correction step corresponds to the namespace replication database correction processing in the embodiment. The namespace replication database update section corresponds to the namespace-following processing in the storage management server in the present invention. The namespace replication database correction section corresponds to the namespace replication database correction processing in the storage management server in the embodiment.

### INDUSTRIAL APPLICABILITY

As described above, the present invention allows the namespace on the storage device to be replicated effectively as a database.

1. A namespace replication program causing a computer to replicate a namespace on a storage device, the program causing the computer to execute:
a namespace replication database update step that acquires namespace update information, which is information relating to updating the namespace, from a file system controller for controlling the storage device and updates, based on the namespace update information, a namespace replication database, which is a database created based upon file identification information and link information in the storage device; and
a namespace replication database correction step that acquires unupdated file identification information, which is file identification information updated after a predetermined time, and unupdated link information, which is link information corresponding to the unupdated file identification information, from the file system controller, and corrects the namespace replication database based upon the unupdated file identification information and the unupdated link information if the namespace update information which has not been reflected on the namespace replication database by the namespace replication database update step is lost.

2. The namespace replication program according to claim 1, wherein
the namespace update information contains a namespace update content, which is an updated namespace content, and a namespace update time, which is an update time for the namespace, and
among the namespace update times contained in the namespace update information which has been reflected on the namespace replication database by the namespace replication database update step, the namespace replication database correction step sets the latest one as the predetermined time.

3. The namespace replication program according to claim 1, wherein
the namespace replication database correction step sets link information contained in a directory file among files shown by the unupdated file identification information as the unupdated link information.

4. The namespace replication program according to claim 1, wherein
the namespace replication database information correction step extracts and acquires the unupdated file identification information and the unupdated link information by notifying the file system controller of the predetermined time.

5. The namespace replication program according to claim 1, wherein
the namespace replication database information correction step acquires namespace update information which has not been reflected on the namespace replication database by the namespace replication database update step before so completing the correction of the namespace replication database, and updates the namespace replication database based upon the acquired namespace update information if the namespace update information has no relationship to the unupdated file identification information.

6. The namespace replication program according to claim 1, wherein
one of the link information contains inode information for one directory file as well as inode information for a child file contained in the directory file and name information for a child file contained in the directory file, and
the namespace replication database has an entry for each of the link information.

7. The namespace replication program according to claim 1, wherein
the file identification information is inode information, and
the link information contains an inode number for one directory file and an inode number for a child file contained in the directory file.

8. The namespace replication program according to claim 2, wherein
the namespace replication database information correction step acquires namespace update information which has not been reflected on the namespace replication database by the namespace replication database update step before completing the correction of the namespace replication database, and corrects the namespace replication database based upon the newer one of the namespace update information and the unupdated file identification information by comparing the namespace change time of the namespace update information with the update time of the upupdated file identification information having some relationship to the namespace update information if the namespace update information has any relationship to the unupdated file identification information.

9. The namespace replication program according to claim 1, wherein the namespace update information is sent collectively in each predetermined period of time by the file system controller and
the namespace replication database information update step updates the namespace replication database based on the namespace update information each time the namespace replication database information update step acquires the namespace update information.

10. A namespace replication device for replicating a namespace on a storage device, comprising:
a namespace replication database update section that acquires namespace update information, which is information relating to updating the namespace, from a file system controller for controlling the storage device and updates, based on the namespace update information, a namespace replication database, which is a database created based upon file identification information and link information in the storage device; and
a namespace replication database correction section that acquires unupdated file identification information, which is file identification information updated after a predetermined time, and unupdated link information, which is link information corresponding to the unupdated file identification information, from the file system controller, and corrects the namespace replication database based upon the unupdated file identification information and the unupdated link information if the namespace update information which has not been reflected on the namespace replication database by the namespace replication database update section is lost.

11. The namespace replication device according to claim 10, wherein
the namespace update information contains a namespace update content which is an updated namespace content, and a namespace update time, which is an update time for the namespace, and
among the namespace update times contained in the namespace update information which has been reflected on the namespace replication database by the namespace replication database update section, the namespace replication database correction section sets the latest one as the predetermined time.

12. A namespace replication method for replicating a namespace on a storage device, comprising:
a namespace replication database update step that acquires namespace update information, which is information relating to updating the namespace, from a file system controller for controlling the storage device in the namespace replication device for managing a namespace replication database, which is a database created based upon file identification information and link information of the storage device, and updates the namespace replication database based upon the namespace update information; and
a namespace replication database correction step that acquires unupdated file identification information, which is file identification information updated after a predetermined time, and unupdated link information, which is link information corresponding to the unupdated file identification information, from the file system controller in the namespace replication device and corrects the namespace replication database based upon the unupdated file identification information and the unupdated link information if the namespace update information which has not been reflected on the namespace replication database by the namespace replication database update step is lost.

13. The namespace replication method according to claim 12, wherein
the namespace update information contains a namespace update content, which is an updated namespace content, and a namespace update time, which is an update time for the namespace, and
among the namespace update times contained in the namespace update information which has been reflected on the namespace replication database by the namespace replication database update step, the namespace replication database correction step sets the latest one as the predetermined time.

14. The namespace replication method according to claim 12, wherein
the namespace replication database correction step sets link information contained in a directory file among files shown by the unupdated file identification information as the unupdated link information.

15. The namespace replication method according to claim 12, wherein
the namespace replication database information correction step acquires the unupdated file identification information in the namespace replication device by notifying the file system controller of the predetermined time in the namespace replication device, enumerating file identification information updated after the predetermined time in the file system controller, and sending the file identification information as unupdated file identification information to the namespace replication device.

16. The namespace replication method according to claim 12, wherein
the namespace replication database information correction step acquires namespace update information which has not been reflected on the namespace replication database by the namespace replication database update step before completing the correction of the namespace replication database in the namespace replication device, and updates the namespace replication database based upon the acquired namespace update information if the namespace update information has no relationship to the unupdated file identification information.

17. The namespace replication method according to claim 12, wherein
one of the link information contains inode information for one directory file as well as inode information for a child file contained in the directory file and name information for a child file contained in the directory file, and
the namespace replication database has an entry for each of the link information.

18. The namespace replication method according to claim 12, wherein
the file identification information is inode information, and
the link information contains an inode number for one directory file and an inode number for a child file contained in the directory file.

19. The namespace replication method according to claim 13, wherein
the namespace replication database information correction step acquires namespace update information which has not been reflected on the namespace replication database by the namespace replication database update step before completing the correction of the namespace replication database in the namespace replication device, and corrects the namespace replication database based upon the newer one of the namespace update information and the unupdated file identification information by comparing the namespace change time of the namespace update information with the update time of the unupdated file identification information having some relationship to the namespace update information if the namespace update information has any relationship to the unupdated file identification information.

20. The namespace replication method according to claim 12, wherein
the namespace replication database information update step records database maintenance information instructing the maintenance of the namespace replication database in the storage device in case of an orderly termination in the file system controller and determines that the namespace update information which has not been reflected on the namespace replication database by the namespace replication database update step is lost when the database maintenance information is not found in the storage device at the time of starting the file system controller, causing the namespace replication device to perform the namespace replication database correction step.
